(19) United States
(12) Patent Application Publication
(10) Pub. No.: US 2025/0020593 A1
(43) Pub. Date: Jan. 16, 2025

(54) DEVICE, METHOD AND COMPUTER READABLE STORAGE MEDIUM FOR QUANTITATIVE PHASE IMAGING

(71) Applicant: Bay Jay Ray Technology Limited, Hong Kong (HK)

(72) Inventors: Renjie ZHOU, Hong Kong (HK); Mengxuan Niu, Hong Kong (HK); Rui Sun, Shenzhen (CN)

(21) Appl. No.: 18/801,596

(22) Filed: Aug. 12, 2024

Related U.S. Application Data
(63) Continuation of application No. 17/454,461, filed on Nov. 10, 2021.

(51) Int. Cl. G01N 21/64; G02B 27/10; G02B 27/14; G02B 27/30

(52) U.S. Cl. CPC G01N 21/6456; G01N 21/6428; G02B 27/1006; G02B 27/149; G02B 27/30; G01N 2021/6439; G01N 2021/6463; G01N 2021/6484; G01N 2201/082; G01N 2201/0826; G01N 2201/12; G02B 2207/113

(57) ABSTRACT

The disclosure herein provides a device, a method and a computer-readable storage medium for quantitative phase imaging, and relates to the field of quantitative phase imaging. The specific implementation scheme is: Obtain a multiplexed interferogram of the sample, where the multiplexed interferogram is a sample beam composed of at least two beams with different wavelengths to illuminate the sample and penetrate into the cube beam splitter Combine at least two beams with different wavelengths as the reference beam, and the combined beam is the imaging image sampled by the camera; and perform phase retrieval on the multiplexed interference image to obtain each beam of the sample in the composite sample beam The phase map at the wavelength of. Using the embodiments of the disclosure herein, one imaging acquisition and one phase retrieval are to acquire the phase maps of at least two wavelength channels.

### CROSS-REFERENCE TO RELATED APPLICATION(S)

This application is a continuation of the U.S. application Ser. No. 17/454,461 filed on 10 Nov. 2021, and entitled “Device, Method and Computer Readable Storage Medium for Quantitative Phase Imaging”.

### TECHNICAL FIELD

The disclosure herein relates to the technical field of optical imaging and computer, and in particular to quantitative phase imaging.

### BACKGROUND

Light microscopes are important tools for research in biology, medicine, material science, and so on. Among them, fluorescence microscopy has been a standard imaging modality for modern cell biology investigations, where targeted cell compartments are labelled with fluorescence tags. Phase-contrast microscopy, as another widely used method, is suitable for observing live cells with improved contrast compared with bright-field microscopy. In recent years, quantitative phase microscopy (QPM), offering precise mapping of sample's refractive index (RI) and thickness distributions, has emerged as an important label-free imaging tool for biological and material structures, e.g., mapping cell morphology, quantification of cell dynamics, digital histopathology, surface profiling of fabricated material structures, detecting defects in patterned silicon wafers, etc.

To make QPM system compact and cost effective to broaden its use, various efforts have been made, such as implementing twin-beam optical design, t interferometer, self-interference with a Wollaston prism, common-path design with pinhole diffraction, on-chip computational imaging, etc. To extend the depth measurement range in off-axis QPM, dual wavelength or three wavelength methods have been invented. To simultaneous offer morphological and molecular information, QPM and fluorescence imaging has been integrated into the imaging platform. On the other hand, obtaining molecular information in a label-free way can simplify sample preparation and minimize perturbations, especially for live biological samples. Spectroscopy methods, such as those based on Raman spectroscopy, absorption spectroscopy, and sample dispersion, can be used to probe molecular compositions in specimen in a label-free manner.

researchers have retrieved dispersion and absorbance properties of proteins and DNA solutions, measured absorption coefficients and refractive index spectra in dispersive samples, quantified hemoglobin concentrations in red blood cells, etc. However, for a comprehensive study of biological and material structures, multiple information dimensions are re-quired (e.g., sample morphology, molecular information, quantification of molecular concentrations, etc.), and specific measurement conditions (e.g., high-speed mapping of sample properties, samples with large thickness, etc.) need to be satisfied. Despite of the various efforts in developing hybrid imaging modalities, there has not been a compact and ease-of-use system that embodies versatile measurement functions for more comprehensive studies in biology and material studies.

### SUMMARY

The disclosure herein provides a device, method, and computer-readable storage medium for quantitative phase imaging.

According to an aspect of the disclosure herein, there is provided advice for quantitative phase imaging, comprising:
at least two light sources with different wavelengths;
at least two fiber couplers;
an optical fiber combiner;
a first collimator lens;
a sample platform;
a 4f system;
at least two cubic beam splitters, each cubic beam splitter is equipped to combine the input sample beam and one reference beam; and a kinematic mount is arranged to adjust the angle of the reference beam and then this beam is collimated with a second collimator lens; and
a camera;
wherein the first collimator lens, the sample platform, the 4f system, the at least two cubic beam splitters, and the camera are placed in sequence, and their centers are on the same optical axis;
the imaging of the device comprises:
the optical fiber coupler divides any light beam input from the at least two light sources with different wavelengths into two beams, one of the two beams is input into the optical fiber combiner, and the other of the beams as a reference beam is input into one of the cube beam splitters, and the optical fiber combiner combines the input beams and outputs a sample beam, which passes through the first collimator lens to illuminate the sample on the sample platform and penetrates into the at least two cubic beam splitters to combine with the reference beams therein, thus a multiplexed interferogram of the sample is captured by the camera.

According to another aspect of the disclosure herein, there is provided a method for quantitative phase imaging, comprising:
obtaining a multiplexed interferogram of a sample, where the multiplexed interferogram is an imaging map captured by a camera when a sample beam synthesized of at least two beams with different wavelengths to illuminate the sample and then penetrate into the cube beam splitter to combine with the at least two beams of different wavelengths as reference beams, and finally the combined beam is imaged by the camera; and
performing a phase retrieval on the multiplexed interferogram to obtain a phase map of the sample at the wavelength of each beam that synthesizes the sample beam.

According to another aspect of the disclosure herein, there is provided a non-transitory computer-readable storage medium storing computer instructions, which are used to make a computer execute the method in any embodiment of the disclosure herein.

According to another aspect of the disclosure herein, there is provided a computer program product, including a computer program, which, when executed by a processor, implements the method in any embodiment of the disclosure herein.

According to the technology of the disclosure herein, a sample can be illuminated with a sample beam synthesized of two or more beams with different wavelengths, and after illumination the sample beam combines with reference beams that synthesizes the sample beam to form a multiplexed interferogram on a camera, thus the disclosure herein can capture an interference pattern of multiple light beams with different wavelengths in one acquisition. And the phase map of each wavelength channel can be reconstructed as the sample information corresponding to these two or more wavelengths in the interference pattern does not overlap in the spatial frequency space. Therefore, in the case of one acquisition and one phase retrieval, the phase maps of the sample in multiple wavelength channels can be obtained, which greatly improves the work efficiency of phase imaging.

It should be understood that the content described in this section is not intended to identify key or important features of the embodiments of the disclosure herein, nor is it intended to limit the scope of the disclosure herein. Other features of the disclosure herein will be easily understood through the following description.

### BRIEF DESCRIPTION OF THE DRAWINGS

The drawings are used to better understand the solution of the disclosure, and do not constitute a limitation to the disclosure herein.

FIG. 1 is a schematic structural diagram of a device for quantitative phase imaging according to a disclosure embodiment.

FIG. 2 is a schematic diagram of a method for quantitative phase imaging according to a disclosure embodiment.

FIG. 3 is a schematic diagram of an apparatus for quantitative phase imaging according to a disclosure embodiment.

FIG. 4A is an original image of a dual wavelength interferogram according to a disclosure embodiment:

FIG. 4B is a Fourier spectrum map with two group 1^{st} order retrieved from the dual wavelength interferogram in FIG. 4A according to a disclosure embodiment.

FIG. 4C is a height map of a part of a Quantitative Phase Microscope Target (QPT) structure measured at 633 nm by the system according to a disclosure embodiment.

FIG. 4D is a height map of the part of the Quantitative Phase Microscope Target (QPT) structure in FIG. 4C measured at 532 nm by the system according to a disclosure embodiment.

FIG. 5A is a retrieved phase map of a 50 μm microbead at 633 nm wavelength according to a disclosure embodiment.

FIG. 5B is a retrieved phase map of the 50 μm microbead in FIG. 5A at 532 nm wavelength according to a disclosure embodiment.

FIG. 5C is a retrieved phase map of a 20 μm red microbead at 633 nm wavelength according to a disclosure embodiment.

FIG. 5D is a retrieved phase map of the 20 μm red microbead in FIG. 5C at 532 nm wavelength according to a disclosure embodiment.

FIG. 5E is an image of the ratio of the refractive index of a 50 μm microbead at 633 nm and 532 nm wavelength according to a disclosure embodiment.

FIG. 5F is an image of the ratio of the refractive index of a 20 μm red microbead at 633 nm and 532 nm wavelength according to a disclosure embodiment.

FIG. 5G is a comparison diagram of the ratio of the refractive index of 50 μm microbeads and 20 μm red beads at 633 nm and 532 nm wavelength according to a disclosure embodiment.

FIG. 6A is a retrieved phase map of a red blood cell at 633 nm wavelength according to a disclosure embodiment.

FIG. 6B is a retrieved phase map of the red blood cell in FIG. 6A at 532 nm wavelength according to a disclosure embodiment.

FIG. 6C is an image of time-lapse changes of red blood cell membrane fluctuations according to a disclosure embodiment.

FIG. 6D is a hemoglobin concentration map of a red blood cell according to a disclosure embodiment (the inset at the bottom left of the hemoglobin concentration map is a concentration histogram of the white circle area of the red blood cell).

FIG. 6E is a histogram of hemoglobin concentration counted from 30 red blood cells according to a disclosure embodiment.

FIG. 6F is an image of time-lapse changes of the hemoglobin concentration changes in one red blood cell according to a disclosure embodiment.

FIG. 7A is a phase map of fluorescent particles calculated by the system according to a disclosure embodiment.

FIG. 7B is a fluorescence image of the fluorescent particles in FIG. 7A captured by the system according to a disclosure embodiment.

FIG. 7C is a fluorescence image of the fluorescent particles in FIG. 7A captured by a Zeiss microscope according to a disclosure embodiment.

FIG. 7D is a phase map of NIH 3T3 cells calculated by the system according to a disclosure embodiment.

FIG. 7E is a fluorescence image of the NIH 3T3 cells in FIG. 7D captured by the system according to a disclosure embodiment.

FIG. 7F is a fluorescence image of the NIH 3T3 in FIG. 7D cells captured by a Leica microscope according to a disclosure embodiment.

FIG. 8A is a retrieved phase image of a 50 μm microbead at 633 nm wavelength according to a disclosure embodiment.

FIG. 8B is a retrieved phase map of the 50 μm microbead in FIG. 8A at 532 nm wavelength according to a disclosure embodiment.

FIG. 8C is a synthesized phase map of the 50 μm microbead in FIG. 8A at a wavelength synthesized of 633 nm and 532 nm wavelengths according to a disclosure embodiment.

FIG. 8D is a corresponding real phase map of the 50 μm microbead in FIG. 8A with the synthetic wavelength according to a disclosure embodiment.

FIG. 8E is a line profile on a 50 μm microbead at 532 nm wavelength according to a disclosure embodiment:

FIG. 8F is a line profile on the 50 μm microbead in FIG. 8E at 633 nm wavelength according to a disclosure embodiment:

FIG. 8G is a line profile on the 50 μm microbead FIG. 8E at a synthetic wavelength synthesized of 633 nm and 532 nm wavelength according to a disclosure embodiment:

FIG. 8H is a physical image of a microfluidic chip with a channel height of 5 μm according to a disclosure embodiment:

FIG. 8I is a retrieved phase map without a phase unwrapping algorithm on the channel of the microfluidic chip in FIG. 8H at 532 nm wavelength according to a disclosure embodiment:

FIG. 8J is the two synthetic wavelength guide phase unwrapping result of the channel of the microfluidic chip in FIG. 8H according to a disclosure embodiment (the right side of the phase map is the histogram of the unwrapped phase map).

### DETAILED DESCRIPTION OF EMBODIMENTS

The following describes exemplary embodiments of the disclosure herein with reference to the accompanying drawings, which include various details of the embodiments of the disclosure herein to facilitate understanding, and should be regarded as merely exemplary. Therefore, those of ordinary skill in the art should recognize that various changes and modifications can be made to the embodiments described herein without departing from the scope and spirit of the disclosure herein. Likewise, for clarity and conciseness, descriptions of well-known functions and structures are omitted in the following description.

In order to facilitate the understanding of the technical solutions of the embodiments of the disclosure herein, the related technologies of the embodiments of the disclosure herein are described below. The following related technologies can be combined with the technical solutions of the disclosure embodiments as optional solutions, and they all belong to the scope of the disclosure herein.

In order to satisfy various imaging applications under different experimental conditions, the disclosure embodiments propose a device for quantitative phase imaging, which can be referred to as a portable multi-modal and multi-wavelength fiber-based quantitative phase microscope (M²QPM). In the proposed device, two or more lights of different wavelengths are multiplexed into an interferogram, from which the quantitative phase maps of the lights of two different wavelengths can be retrieved for profiling samples with extended depth. Moreover, the device uses fiber optic components to propagate sample beams and reference beams, and it is carefully adjusted the length of the optical path in the fiber to achieve off-axis interference measurement, which also improves the stability and compactness of the device for quantitative phase imaging. Based on the hardware structure of the quantitative phase imaging device itself and the multiplexed interferogram obtained by imaging, the disclosure embodiments can open up a variety of applications, such as various parameters of the sample can be measured in real time, including thickness, refractive index, morphological information, fluorescence information, absorption characteristics, etc.

In one application, according to phase mapsat two or more different wavelengths of light used in imaging, a physical model can be derived to map dispersion parameters of samples, which can be used to characterize dispersive samples in real time, such as hemoglobin concentration of red blood cells.

In one application, the phase maps of light of two or more different wavelengths is used to phase unwrap the synthesized phase map of the light synthesized by these lights, and then based on the unwrapped synthesized phase map and the synthetic wavelength synthesized of wavelengths of these lights. calculate the height map of the sample, which can truly reflect sample profiles.

In one application, based on the device for quantitative phase imaging, an appropriate fluorescence filter can be arranged in front of the camera plane to realize fluorescence imaging, and with quantitative phase imaging applied to cell imaging. Fluorescence imaging and phase imaging can pass through the same optical system and use the same camera. It is only necessary to add an appropriate fluorescence filter in front of the camera plane during fluorescence imaging, without using dichroic mirrors for separation.

Hereinafter, the imaging device and various imaging applications proposed by the disclosure embodiments will be exemplified.

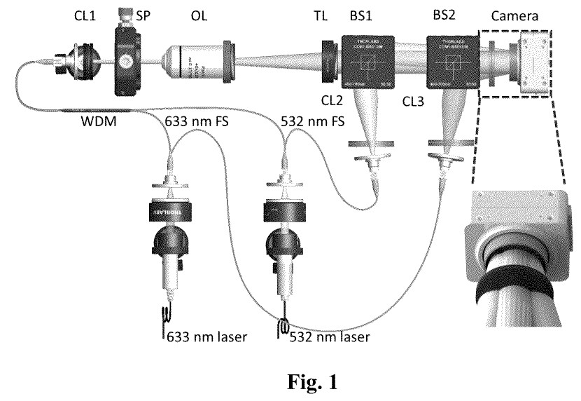

Refer to FIG. 1, which show a schematic structural diagram of a device for quantitative phase imaging according to a disclosure embodiment. There is provided a device, comprising: at least two light sources with different wavelengths, at least two fiber couplers, an optical fiber combiners, a first collimator lens, a sample platform, a 4f system, at least two cubic beam splitters and a camera. The first collimator lens, the sample platform, the 4f system, the at least two cubic beam splitters and the camera are placed in sequence, and their centers are on the same optical axis.

The number of light sources, fiber couplers and cubic beam splitters can be the same or different. The number of fiber couplers and cubic beam splitters can be the same.

Exemplarily, as shown in FIG. 1, in the M²QPM system, two or more light sources, two fiber couplers and two cubic beam splitters are provided. During the imaging process, these two light sources can be connected to the two fiber couplers separately or two light sources can be selected from more than two light sources to be connected to the two fiber couplers respectively. Each fiber coupler divides the input light into two beams, one of which is input to the fiber combiner through an optical fiber, and the other is connected to a cubic beam splitter through an optical fiber, as a reference beam. The fiber combiner combines the two input beams with different wavelengths into a sample beam to illuminate the sample. This example can realize the multiplexed interference of dual-wavelength light.

Illustratively, in the M²QPM system, three or more light sources, three fiber couplers and three cubic beam splitters are provided. During the imaging process, three of the light sources can be selected from more than three light sources to be connected to the three fiber couplers respectively, that is, one light source is connected to one fiber coupler. Each fiber coupler divides the input light into two beams, one beam is input to the fiber combiner through an optical fiber, and the other beam is connected to a cubic beam splitter through an optical fiber as the reference beam. This example can realize the multiplexed interference of three-wavelength light.

For the multiplexed interference of light of four or more wavelengths, it can be referred to these two examples for setting.

The disclosure embodiments take FIG. 1 as an example, and uses dual-wavelength phase imaging and its application for description.

As shown in FIG. 1, the sample beam obtained above is expanded and collimated by the first collimator lens to illuminate the sample on the sample platform with appropriate beam sizes. After the sample, the imaging field is magnified by the 4f system, which consists of an objective lens and a tube lens. Exemplarily, the size of the objective lens of the 4f system may be 40×/0.65, the magnification is 40 times, and the aperture is 0.65. The focal length of the tube lens of the 4f system may be 150 mm.

The cubic beam splitter is equipped with a second collimator lens to expand and collimate the reference beam, which would enter the cube beam splitter with appropriate beam sizes. A kinematic mount is installed at the input end of the second collimator lens, which can adjust the angle of the input reference beam.

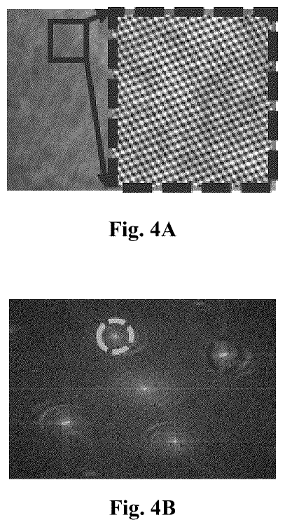

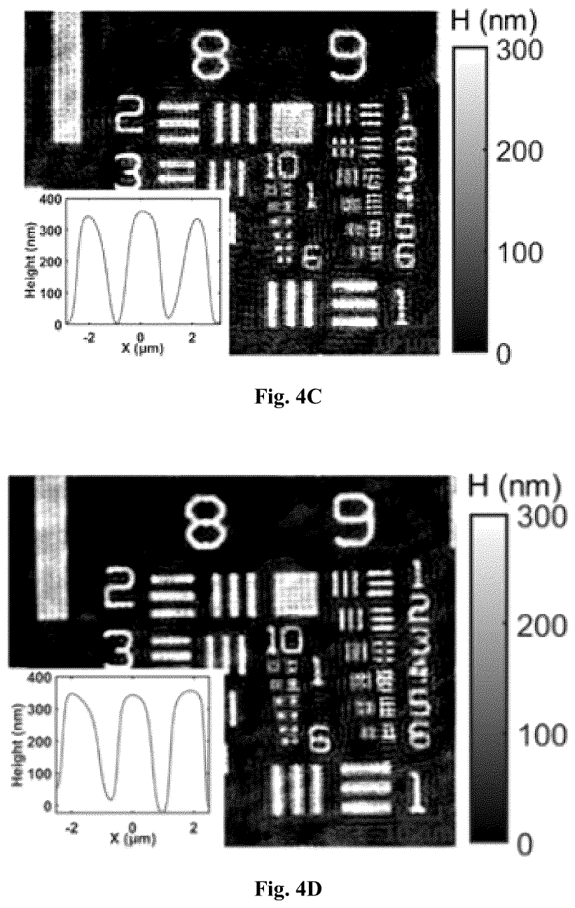

The sample beam is amplified by the 4f system and combined with the two reference beams incident on the two cube beam splitters through two cube beam splitters to form a multiplexed interference pattern on the camera. Exemplarily, the wavelengths of the two light sources in FIG. 1 can be 633 nm and 532 nm, and the multiplexed interference pattern obtained in the camera includes two sets of interference fringes at the wavelengths of 633 nm and 532 nm, which can be as shown in FIG. 4A. These light sources can also be selected from commonly used visible light such as 405 nm (blue-violet light) and 488 nm (blue light). Exemplarily, the camera may be configured to operate at a frame rate of 60 fps and the pixel resolution is 2080×1552, and the device of the disclosure herein can quickly capture the dynamics of the sample with a field of view of about 150 μm×110 μm.

The disclosure embodiments can illuminate a sample with a sample beam synthesized by two or more beams with different wavelengths, and use the beams participating in the synthesis of the sample beam as the reference beams, which are combined with the sample beam after irradiating the sample, so that the camera can capture their interference pattern in a single acquisition. Moreover, since the sample information corresponding to these two or more wavelengths in the interference pattern does not overlap in the spatial frequency space, the phase map of each wavelength channel can be reconstructed. Therefore, in the case of one acquisition and one phase retrieval, the phase maps of the sample in multiple wavelength channels can be obtained, which greatly improves the work efficiency.

In addition, in the M²QPM system, the use of fiber optic components such as fiber couplers, fiber combiners and cubic beam splitters helps to reduce the space of the system. In order to further take the advantages of optical fiber and ensure interference with a minimized system dimension, a piece of optical fiber can be spliced in each output of each fiber coupler to connect to the fiber combiner and cube beam splitter. The length of the spliced fiber is determined by matching the total optical path length of the two output beams from the fiber coupler. Since the optical fiber can be folded and coiled, and most of the optical path of the light beam is in the coiled fiber during propagation, the light beam can be folded to minimize the extension of the imaging device.

The imaging device provided by the disclosure embodiments may also include a processor for data processing and analysis of the imaging map of the device to open up new applications, such as real-time measurement of various parameters of the sample, including phase, thickness, refractive index, morphological information, fluorescence information and absorption characteristics, etc.

The disclosure embodiments can obtain the interference pattern of a sample illuminated by multiple wavelength-combined beams in one collection. As the sample information corresponding to multiple wavelengths does not overlap in the spatial frequency space, the phase retrieval algorithm based on the Fourier transform can reconstruct the phase map of the sample in each wavelength channel.

In the M²QPM system, the same optical system and the same camera can be used for fluorescence imaging and phase imaging, and there is no need to use dichroic mirrors for separation. In fluorescence imaging, the sample is coated with fluorescent dyes in advance, and a band-pass filter is placed in front of the camera plane. The fluorescent dye has a maximum excitation wavelength and a maximum emission wavelength. Since the imaging device of the disclosure herein is provided with multiple light sources of different wavelengths, a appropriate excitation light source can be selected from them to perform fluorescence imaging. At the same time, the cut-off wavelength of the band-pass filter should also meet the wavelength requirements of the excitation light source and the fluorescent dye. That is, the wavelength of the excitation light source needs to be greater than the maximum excitation wavelength of the fluorescent dye. The cut-off wavelength of the pass filter is between the wavelength of the excitation light source and the maximum emission wavelength of the fluorescent dye. The process of fluorescence imaging is as follows: the excitation light source emits a light beam and illuminates the sample on the sample platform through the first collimator lens to make the sample emit fluorescence, and the fluorescence sequentially passes through the 4f system and the at least two cubic beam splitter, thus the camera captures the fluorescence image of the sample.

After obtaining the fluorescence image of the sample, one of the light sources can be selected from multiple light sources for quantitative phase imaging, which is single-wavelength phase imaging.

Exemplarily, before imaging, fiber cells are stained with 0.1 mg/ml Nile Blue Sulfate. Then, the dyed fiber cells are placed on the sample platform of the imaging device for fluorescence imaging. The maximum excitation wavelength of Nile blue sulfate is 620 nm, and the maximum emission wavelength is 680 nm. Taking FIG. 1 as an example, the light source of the imaging device includes light sources with wavelengths of 633 nm and 532 nm, from which a light source with a wavelength of 633 nm can be selected to excite fiber cells, and a long-wavelength bandpass filter with a cut-off wavelength of 650 nm is placed in front of the camera plane, then the camera can capture fluorescence images of fiber cells. On the other hand, a 532 nm light source can be used for single-wavelength phase imaging. Combining the fluorescence image of the sample with the phase image is helpful to analyze the morphological information and internal molecular structure information of the sample cells, so as to clearly distinguish the cell structure such as cell membrane, cytoplasm and nuclear area, etc.

Generally speaking, in quantitative phase imaging, for objects (samples) whose optical depth is greater than the wavelength of illumination, the phase image contains 2π discontinuities. However, most of the existing phase unwrapping algorithms used to eliminate discontinuities require subjective intervention, such as the Goldstein phase unwrapping algorithm. In order to solve the problem of discontinuity in the phase map obtained when the height step of the sample is greater than the wavelength of the light irradiating the sample, an embodiment of the disclosure herein proposes a phase unwrapping method that uses the phase maps of the sample at two wavelengths to create a synthesized phase map corresponding to the synthetic wavelength, and unwrap the synthesized phase map of the synthetic wavelength.

Taking FIG. 1 as an example, there are two light beams with wavelengths of a first wavelength and a second wavelength that synthesizes the sample beam. The processor of the imaging device obtains the dual-wavelength multiplexed interferogram of the sample based on the aforementioned phase imaging process, and performs phase retrieval on the dual-wavelength multiplexed interferogram to obtain the phase maps of the sample at the first wavelength and at the second wavelength. The processor can also perform the following phase unwrapping process:
determining a synthesized phase map of the sample at the wavelength synthesized by the first wavelength and the second wavelength, according to the phase map of the sample at the first wavelength and that at the second wavelength; and
adding a period of 2π on each negative phase in the synthesized phase map to obtain an unwrapping phase map.

Exemplarily, the first wavelength λ₁ is 633 nm, and the second wavelength λ₂ is 532 nm. According to the following equation (1), the synthetic wavelength A is calculated to be 3334.2 nm.

$$Λ = \frac{{λ}_{1} \cdot λ2}{{λ}_{2} - {λ}_{1}} \qquad ( 1 )$$

The phase map of the sample at the first wavelength λ₁ isφ₁ (x,y), and the phase map of the sample at the second wavelength λ₂ isφ₂ (x,y). Subtract the two phase maps to obtain the phase map corresponding to the synthetic wavelength, as shown in the following formula:

$${φ}_{Λ} ( x , y ) = {φ}_{2} ( x , y ) - {φ}_{1} ( x , y ) \qquad ( 2 )$$

Due to the mismatch between the two wrapping phase maps at these two wavelengths, there may be some phase jumps. When there is a negative phase in the synthesized phase map, add a period of 2π to the negative phase to solve the above-mentioned mismatch problem, thereby performing phase unwrapping.

For the height map of the sample, it can be calculated according to the following formula:

$$H = \frac{{φ}_{1} ( x , y ) {λ}_{1}}{2 πΔ n} = \frac{{φ}_{2} ( x , y ) {λ}_{2}}{2 πΔ n} = \frac{{φ}_{Λ} ( x , y ) Λ}{2 πΔ n} \qquad ( 3 )$$

Where Δn is the refractive index contrast between the main substance in the sample and the medium in the sample.

Based on formula (3), using the synthesized phase map to convert the phase to the height, the height map of the sample can still be calculated. Therefore, the sample height map calculated based on the synthesized phase map after unwrapping can truly reflect the height profile of the sample without subsequent interference processing. That is, for samples with an optical depth greater than the wavelength of illumination, the embodiments of the disclosure herein can still accurately measure the height, maintaining high phase sensitivity and stability.

The imaging device proposed in the disclosure embodiments can not only accurately measure the phase and height of the sample, but also can calculate the refractive index change of the sample in a single image through a multi-wavelength design, so as to further observe the dispersion and absorption characteristics of the sample in different wavelength ranges.

Taking FIG. 1 as an example, there are two light beams with wavelengths of a first wavelength and a second wavelength that synthesizes the sample beam. The processor of the imaging device obtains the dual-wavelength multiplexed interferogram of the sample based on the aforementioned phase imaging process, and performs phase retrieval on the dual-wavelength multiplexed interferogram to obtain the phase maps of the sample at the first wavelength and at the second wavelength. These two phase maps can be converted into height maps by the following formula:

$$H ( x , y ) = \frac{{λ}_{1} {φ}_{1} ( x , y )}{2 πΔ {n}_{1}} = \frac{{λ}_{2} {φ}_{2} ( x , y )}{2 πΔ {n}_{2}} \qquad ( 4 )$$

where H(x,y) is the height map, λ₁ is the first wavelength, λ₂ is the second wavelength, φ₁(x,y) is the phase map of the sample at the first wavelength, and φ₂(x,y) is the sample at the first wavelength. The phase map at the second wavelength, and Δn₁ is the refractive index contrast between the sample and the medium at the first wavelength, and Δn₂ is the refractive index contrast between the sample and the medium at the second wavelength.

Therefore, in combination with formula (4), the processor of the imaging device can determine a ratio of the refractive index of the sample at the first wavelength and at the second wavelength, according to the phase maps of the sample at the first wavelength and that at the second wavelength. Specifically, the ratio of refractive index at two wavelengths can be calculated based on the following formula:

$$\frac{{n}_{1}}{{n}_{2}} = \frac{{λ}_{1} {φ}_{1} ( x , y )}{{λ}_{2} {φ}_{2} ( x , y )} \qquad ( 5 )$$

where n₁ is the refractive index of the sample at the first wavelength, and n₂ is the refractive index of the sample at the second wavelength.

Therefore, through the ratio of the refractive index of the sample at any two wavelengths, the dispersion and absorption characteristics of the sample at different wavelengths can be observed and analyzed.

Different types of molecules in the sample can be distinguished by their dispersion. For example, hemoglobin has obvious dispersion at the wavelength of visible light, so the distribution and concentration of hemoglobin in red blood cells can be calculated by measuring the dispersion characteristics of hemoglobin.

The process of calculating the hemoglobin concentration in red blood cells by the processor of the disclosure embodiments may be as follows:
determining a relative average refractive index of other molecules besides hemoglobin in the red blood cells; and
determining a hemoglobin concentration in the red blood cells, according to the relative average refractive index and two phase maps of the red blood cells at the wavelengths of any two light beams that synthesize the sample beam.

Exemplarily, taking FIG. 1 as an example, there are two light beams with wavelengths of a first wavelength and a second wavelength that synthesizes the sample beam. The imaging device can calculate the hemoglobin concentration in red blood cells according to the following formula:

$${c}_{Hb} = \frac{{n}_{X} ( {φ}_{2} {λ}_{2} - {φ}_{1} {λ}_{1} )}{{φ}_{1} {λ}_{1} α ( {λ}_{2} ) - {φ}_{2} {λ}_{2} α ( {λ}_{1} )} \qquad ( 6 )$$

where c_{Hb} is the hemoglobin concentration in red blood cells, nₓ is the relative average refractive index of other molecules in red blood cells except hemoglobin, which is an independent constant of wavelength, α(λ₁) is the refractive index increment of hemoglobin at the first wavelength λ₁, α(λ₂) is the refractive index increment of hemoglobin at the second wavelength λ₂,φ₁ is the phase map of hemoglobin at the first wavelength λ₁, and φ₂ is the phase map of hemoglobin at the first wavelength λ₂.

The imaging device of the embodiment of the disclosure herein may further include a display, which is used to display the image of the sample captured by the camera and the data and images or maps obtained after the processor processes the captured image.

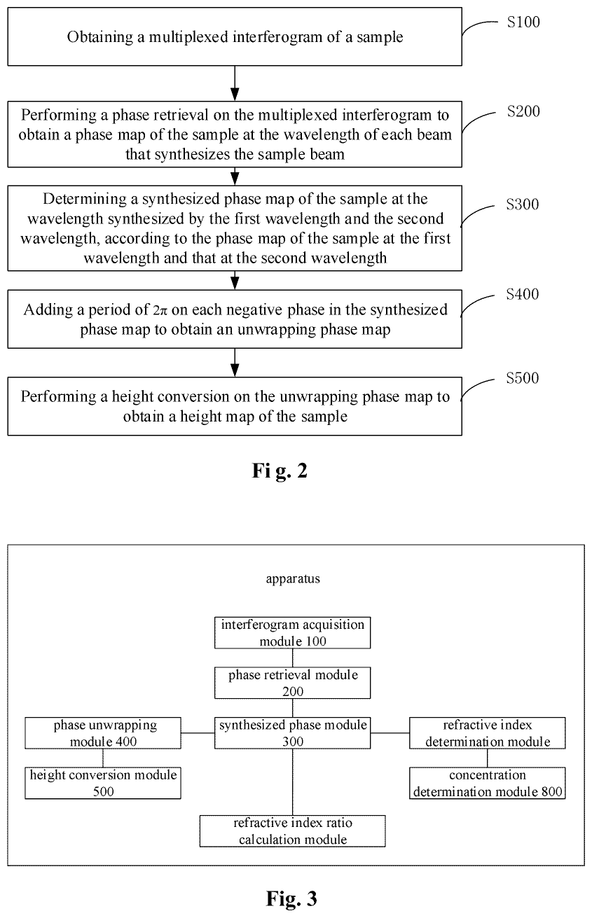

Refer to FIG. 2, which shows a schematic diagram of a method for quantitative phase imaging according to a disclosure embodiment. The method comprises:

S100. Obtaining a multiplexed interferogram of a sample, where the multiplexed interferogram is an imaging map captured by a camera when a sample beam synthesized of at least two beams with different wavelengths to illuminate the sample and then penetrate into the cube beam splitter to combine with the at least two beams of different wavelengths as reference beams, and finally the combined beam is sampled by the camera.

S200. Performing a phase retrieval on the multiplexed interferogram to obtain a phase map of the sample at the wavelength of each beam that synthesizes the sample beam.

Exemplarily, here are at least two light beams with wavelengths of a first wavelength and a second wavelength that synthesizes the sample beam and as shown in FIG. 2 the method further comprises:

S300. Determining a synthesized phase map of the sample at the wavelength synthesized by the first wavelength and the second wavelength, according to the phase map of the sample at the first wavelength and that at the second wavelength.

S400. Adding a period of 2π on each negative phase in the synthesized phase map to obtain an unwrapping phase map.

Exemplarily, as shown in FIG. 2, the foregoing method may further include:

S500. Performing a height conversion on the unwrapping phase map to obtain a height map of the sample.

Exemplarily, there are at least two light beams with wavelengths of a first wavelength and a second wavelength that synthesizes the sample beam and the method further comprises:

Determining a ratio of the refractive index of the sample at the first wavelength and at the second wavelength, according to the phase map of the sample at the first wavelength and that at the second wavelength.

Exemplarily, the sample is red blood cells, and the above method further includes:
determining a relative average refractive index of other molecules besides hemoglobin in the red blood cells;
determining a hemoglobin concentration in the red blood cells, according to the relative average refractive index and two phase maps of the red blood cells at the wavelengths of any two light beams that synthesize the sample beam.

Refer to FIG. 3, which shows a schematic diagram of an apparatus for quantitative phase imaging according to a disclosure embodiment. The apparatus includes:
a interferogram acquisition module 100, which is configured to obtain a multiplexed interferogram of a sample, where the multiplexed interferogram is an imaging map captured by a camera when a sample beam synthesized of at least two beams with different wavelengths to illuminate the sample and then penetrate into the cube beam splitter to combine with the at least two beams of different wavelengths as reference beams, and finally the combined beam is sampled by the camera; and
a phase retrieval module 200, which is configured to perform a phase retrieval on the multiplexed interferogram to obtain a phase map of the sample at the wavelength of each beam that synthesizes the sample beam

Exemplarily, there are at least two light beams with wavelengths of a first wavelength and a second wavelength that synthesizes the sample beam. As shown in FIG. 3, the above-mentioned apparatus may further include:
a synthesized phase module 300, which is configured to determine a synthesized phase map of the sample at the wavelength synthesized by the first wavelength and the second wavelength, according to the phase map of the sample at the first wavelength and that at the second wavelength; and
a phase unwrapping module 400, which is configured to add a period of 2π on each negative phase in the synthesized phase map to obtain an unwrapping phase map

Exemplarily, as shown in FIG. 3, the foregoing apparatus may further include:
a height conversion module 500, which is configured to perform a height conversion on the unwrapping phase map to obtain a height map of the sample.

Exemplarily, there are at least two light beams with wavelengths of a first wavelength and a second wavelength that synthesizes the sample beam. As shown in FIG. 3, the above-mentioned apparatus may further include:
a refractive index ratio calculation module 600, which is configured to determine ta ratio of the refractive index of the sample at the first wavelength and at the second wavelength, according to the phase map of the sample at the first wavelength and that at the second wavelength.

Illustratively, the sample is red blood cells. As shown in FIG. 3, the above apparatus further includes:
a refractive index determination module 700, which is configured to determine a relative average refractive index of other molecules besides hemoglobin in the red blood cells; and
a concentration determination module 800, which is configured to determine a hemoglobin concentration in the red blood cells, according to the relative average refractive index and two phase maps of the red blood cells at the wavelengths of any two light beams that synthesize the sample beam.

Referring to FIGS. 1 to 8, the following will describe application examples of the disclosure herein in combination with experimental results:

### 1. Imaging System

The system of this application example can be shown in FIG. 1, where a 633 nm laser and a 532 nm laser are used as illumination sources. Both beams are fed into two 1×2 single-mode fiber couplers (FC 1, FC 2), respectively. For each fiber coupler, the input beam is divided into two arms, one output arm is used as the sample beam and the other output arm is used as the reference beam. A fiber combiner is used to merge these two sample beams of different wavelengths. After the fiber combiner, the sample beam is expanded and collimated by an aspheric lens CL1 to illuminate the sample with appropriate beam sizes. After the sample, the imaging field is magnified by a 4f system composed of an objective lens (OL) (Zeiss, 40×/0.65, air) and a tube lens (TL) with a focal length of 150 mm. The use of fiber couplers and combiners helps reduce the package size of the system.

To further take the advantages of optical fibers and ensure interference with a minimized system dimension, this application example splices a section of optical fiber in each reference fiber arm of each fiber coupler. For this task, this application example uses a fiber cleaver, a fiber fusion splicer, and an extra piece single-mode fiber that matches the fiber type of fiber couplers. Lengths of the spliced fiber are determined by matching the total optical path length of the sample beam and the total optical path length of the reference beam. As the beam is mostly propagated in the coiled fiber, the beam is folded to minimize the extension of the system. The reference beams, namely reference 1 and reference 2, are expanded and collimated by lenses CL2 and CL3. Kinematic mounts installed at the inputs of the lenses CL2 and CL3 are used to adjust the angle of the reference beams. The sample beam is combined with the reference beam through two cube beam splitters BS1 and BS2 to form a multiplexed interferogram on a camera (FL3-U3-32S2M-CS, PointGrey). The multiplexed interferogram contains two sets of interference fringes at wavelengths of 633 nm and 532 nm.

On the camera sensor, this application example obtains two sets of almost vertical interference fringes, as shown in FIG. 4A. The samples can be illuminated with two different wavelengths of light at the same time, and their interference patterns will be obtained under one acquisition. Since the sample information corresponding to the two wavelengths does not overlap in the spatial frequency space, the phase map of each wavelength channel can be reconstructed. This application example uses a phase retrieval algorithm based on Fourier transform to reconstruct the phase map of the sample. FIG. 4B is a phase map corresponding to the interferogram of FIG. 4A. As the camera of this application example can be configured to operate at a frame rate of 60 fps with a pixel resolution of 2080×1552, the system of this application example can capture fast sample dynamics with a field of view of about 150 μm×110 μm.

The system of this application example is characterized to have a lateral resolution is 0.87 μm and a path-length measurement sensitivity of 0.9 nm for 633 nm wavelength, while 0.78 μm lateral resolution and a path-length measurement sensitivity of 0.7 nm for 532 nm wavelength illumination.

For the sensitivity analysis and calibration of the interference system, environmental factors such as mechanical vibration, air density fluctuations and instrument parameters such as camera dark noise, quantum efficiency and dynamic range of the cameras may all affect it. Phase noise is usually characterized by Optical Path-length Difference (OPD), which is an important factor affecting system performance and can be used to characterize the spatial and temporal sensitivity of a QPM system. The phase noise can be determined using the following formula:

$$δφ = \frac{1}{\sqrt{N}} \qquad ( 7 )$$

As shown in formula (7), it refers to the highest theoretical shot noise limit sensitivity that can be achieved, where N is the maximum electron well depth of the camera. For the PointGrey camera which model number is FL3-U3-32S2M-CS used in this application example, the electron well depth is 10066.31. Therefore, the highest phase sensitivity of this system herein corresponds to 0.00997 rad. If the OPD is used to characterize noise, it should be 0.84 nm.

In the experimental setup of this application example, by using our design of an optical fiber-based portable interferometer, the phase noise caused by mechanical vibration is expected to be minimized as the travel distance of the beam in the air is significantly reduced. In this application example, the system phase noise characteristics in the absence of a sample are measured, and 300 interferograms are obtained at 60 fps and their corresponding OPDs are retrieved. The result shows that the spatial phase noise histogram which exhibits a Gaussian-like profile and has a standard deviation of 0.76 nm as the spatial noise and the temporal phase noise histogram with a 0.99 nm median value as the temporal phase noise under 532 nm illumination. In summary, the result of 0.99 nm is very close to the minimum noise value, and this system achieves comparable nanoscale phase sensitivity to previously reported in laser-based QPM systems.

According to the Abbe criterion, the lateral resolution of the imaging system of this application example with green light is λ/NA≈0.82 μm (or full-pitch resolution). To further validate the resolution of the system, we have measured the phase resolution target (Quantitative Phase Microscope Target (QPT), Benchmark Technologies Corporation, U.S.). FIG. 4C shows the height map of the structures in the QPT sample under the 633 nm illumination. In the lower left illustration of FIG. 4C, it shows the line profile of Group 9 element 2. The peaks due to each line are clearly observable determining a lateral resolution to be 0.87 μm. FIG. 4D shows the height map obtained from this system with the 532 nm illumination, and the lower left inset shows the line profile of Group 9 element 3, representing a system resolution of 0.78 μm under 532 nm illumination, which agrees with the value as documented. On the other hand, the mean height of the sample features on the QPT sample were documented to be around 300 nm. After converting the recovered phase value into a physical thickness (the refractive index of the QPT material is about 1.52), it can be found that the recovered height value is the same as the value given by the manufacturer.

### 2. Dispersion Characterization

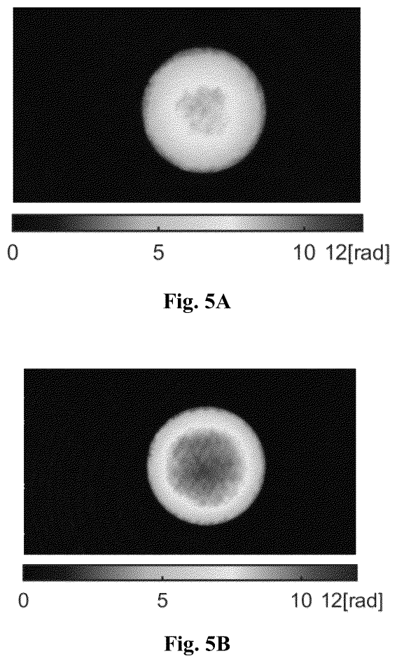

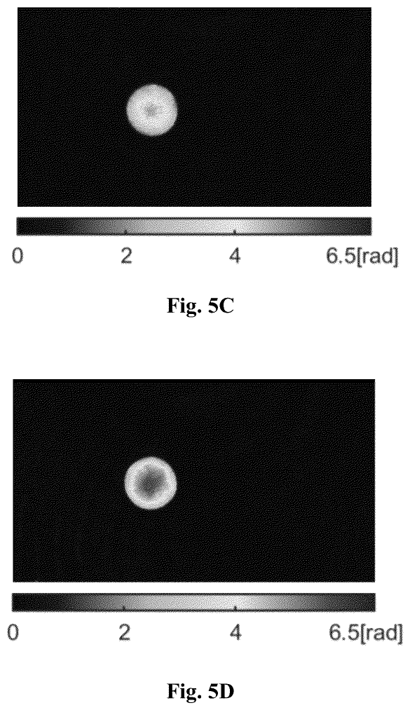

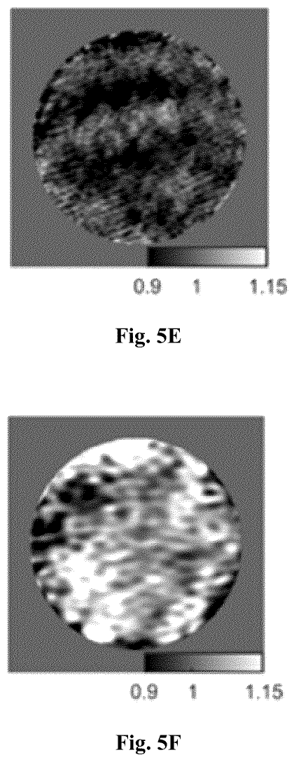

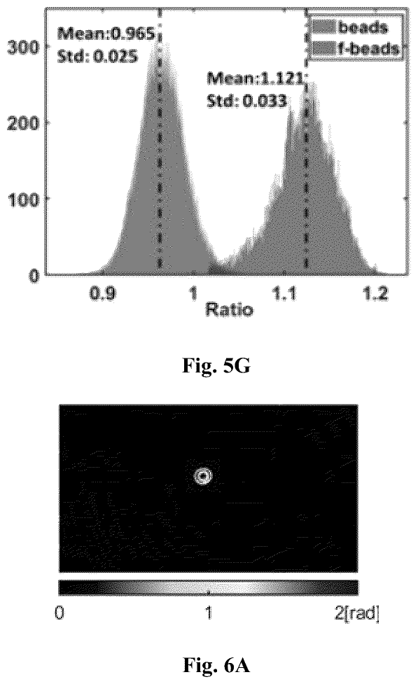

This part will prove the dispersion characterization capability proposed in the system using this application example. First, this application example tests the phase and height imaging performance and refractive index contrast by measuring calibration samples. In this application example, the sample for testing is 50 μm microbeads and fluorescent particles, and the microbead samples for measurement are Thermo 4205A microbeads with a diameter of 50 μm. These polystyrene beads (with a refractive index of 1.59) are suspended in a index matching liquid (with a refractive index of 1.57). From the system, the two phase maps retrieved from two different wavelengths, containing one bead, can be shown in FIG. 5A and FIG. 5B. FIGS. 5A and 5B are two phase maps of 50 μm beads at 633 nm and 532 nm, and FIGS. 5C and 5D are two phase maps of 20 μm beads at 633 nm and 532 nm. The phase map can be converted to a height map by the following formula:

$$H ( x , y ) = \frac{{λ}_{1} {φ}_{1} ( x , y )}{2 πΔ {n}_{1}} = \frac{{λ}_{2} {φ}_{2} ( x , y )}{2 πΔ {n}_{2}} \qquad ( 4 )$$

where λ₁=633 nm and λ₂=532 nm are the wavelengths of the laser light sources, Δn₁ is the refractive index contrast between the beads and the medium under illumination of the wavelength of 633 nm, and Δn₂ is the refractive index contrast between the beads and the medium under illumination of 532 nm wavelength. From the experimental results, FIG. 5C is obtained, which indicates that the ratio between the refractive index of the microbeads at a wavelength of 633 nm and the refractive index at a wavelength of 532 nm is about 0.965.

Monodisperse fluorescent microspheres are prepared by combining fluorescent molecules on the matrix or surface of polystyrene microspheres. Fluorescent microspheres have the characteristics of high fluorescence intensity and strong dispersion properties. Its maximum excitation wavelength is 620 nm, and its maximum emission wavelength is 680 nm. It can be proved that in the system of this application example, there is a significant difference in the absorption of the two wavelengths of 633 nm and 532 nm by the fluorescent particles. This also demonstrates the same theory as reported in our experimental results. From the phase maps obtained in FIGS. 5C and 5D, and further calculate the ratio of Δn, the ratio can be as shown in FIGS. 5E-5G. It can be found that there is a significant difference between the absorption of light at a wavelength of 633 nm and a wavelength of 532 nm for the fluorescent particles of 20 μm. This application example also calculated the refractive index of several fluorescent particles and polystyrene beads in the experiment for comparison, and the calculation results of the mean value and standard deviation value are shown in FIG. 5G. In FIG. 5G, the waveform on the left represents polystyrene beads, and the refractive index ratio is 0.965, which is less than 1. The waveform on the right represents fluorescent particles, and the result shows a ratio of Δn higher than 1, mainly due to the strong absorption of fluorescent particles at 633 nm wavelength and resulting in a higher refractive index of the particles. We also have done the theoretical calculation with the manufacture's datasheet for both kinds of beads. For the dispersive-less material, i.e, the 50 μm polystyrene beads and the standard refractive index matching oil, the refractive index contrasts of these two wavelengths are 0.0211 and 0.0219 respectively. Thus, by dividing these two contrasts, the refractive index ratio of 50 μm polystyrene beads under illumination with wavelengths of 633 nm and 532 nm is about 0.9635, which is in good agreement with the experimental average value. As for fluorescent particles as dispersive materials, in some previous studies, the refractive index of similar red fluorescent particles at visible wavelength range has been measured. The refractive index contrast between red fluorescent particles and standard refractive index matching oil under illumination with wavelengths of 633 nm and 532 nm is 0.0246 and 0.0219, which results in a calculated ratio of approximately 1.1250, and is consistent with the experimental result values shown in FIG. 5G. This result validates that the system proposed in this application example has capability to accurately measure the refractive index dispersion. The M²QPM system proposed in this application example can not only accurately measure the phase and height of the sample, but also calculate the change in refractive index of the sample in a single shot photograph through a design of multiple wavelengths of illumination, which can be further used to provide sample dispersion and absorption properties at different wavelength range.

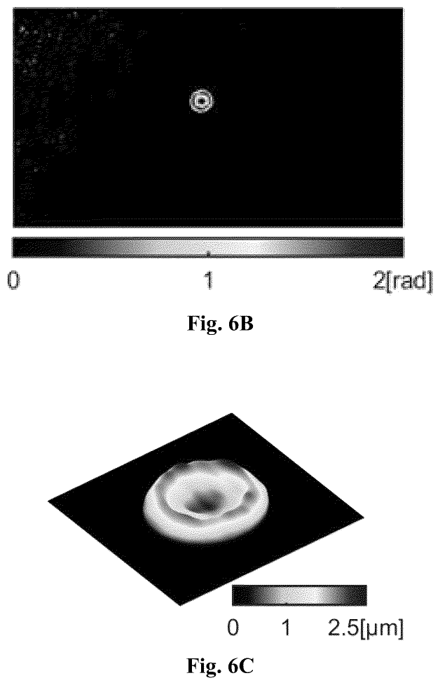

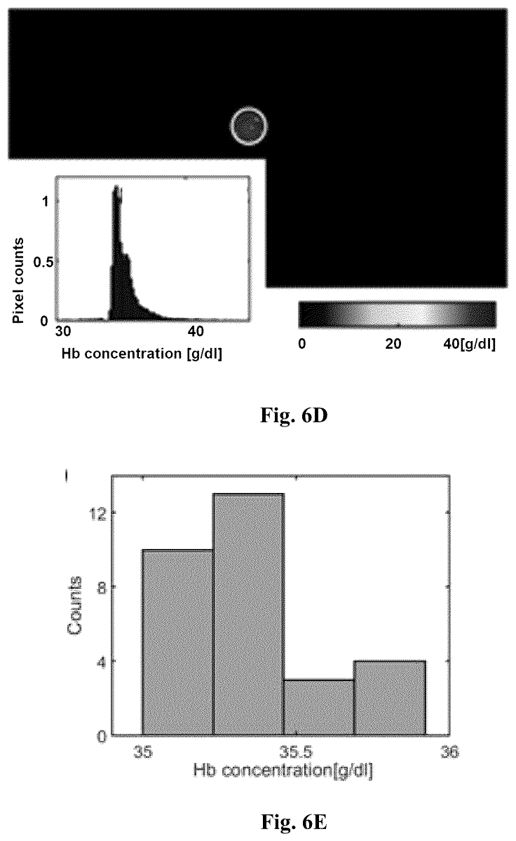

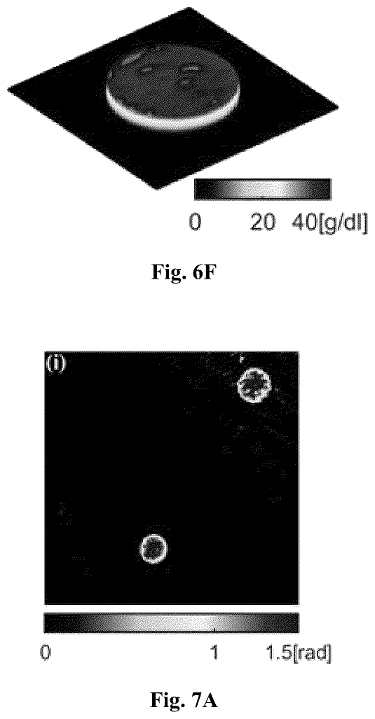

Many types of molecules can be distinguished by their dispersion. For example, hemoglobin (Hb) has obvious dispersion at the wavelength of visible light, so the distribution and concentration of hemoglobin in red blood cells (RBC) can be calculated by measuring its dispersion characteristics. The system based on this application example can demonstrate the simultaneous extraction of cell membrane fluctuations and the dispersion characteristics of a single complete RBC via the wavelength-dependent refractive index measurements. FIGS. 6A and 6B show the phase maps of the RBC retrieved under the illumination of 633 nm and 532 nm wavelengths respectively.

Then, we further calculate the refractive index of the selected cells and calculate the hemoglobin concentration. The model provided in this application example reveals the relationship between hemoglobin concentration and phase measurement as follows:

$${c}_{Hb} = \frac{{n}_{X} ( {φ}_{2} {λ}_{2} - {φ}_{1} {λ}_{1} )}{{φ}_{1} {λ}_{1} α ( {λ}_{2} ) - {φ}_{2} {λ}_{2} α ( {λ}_{1} )} \qquad ( 6 )$$

where α(λ_{1,2}) is a specific refractive index increment for Hb and it is definite at each wavelength. nₓ is a relative average refractive index of molecules other than Hb in RBCs, which is an independent constant of wavelength. As shown in FIG. 6D, it shows a map of hemoglobin concentration in a single red blood cell and its histogram on the lower left, where the mean value of hemoglobin concentration is 35.47 g/dl and a standard deviation is 2.68. In this application example, statistical analysis can also be performed by calculating the hemoglobin concentration of thirty different red blood cells. The experimental result is shown in the form of a histogram in FIG. 6E with an average value of 35.35 g/dl over the entire data sets, which is within the normal physiological range (32-36 g/dl).

FIGS. 6C and 6F respectively show a screenshot of a time-lapse video of RBC film fluctuations and a screenshot of a time-lapse video of changes in the Hb concentration of RBC. The method proposed in this application example can realize the realtime label-free detection of an individual RBC and its concentration calculation could be implemented. Compared with other methods, the M²QPM system can observe real-time changes through simultaneous imaging and thus would be more suitable for detecting sudden changes of environmental effects on the hemoglobin concentration of red blood cells and analyzing its biological state.

### 3. Fluorescence Imaging

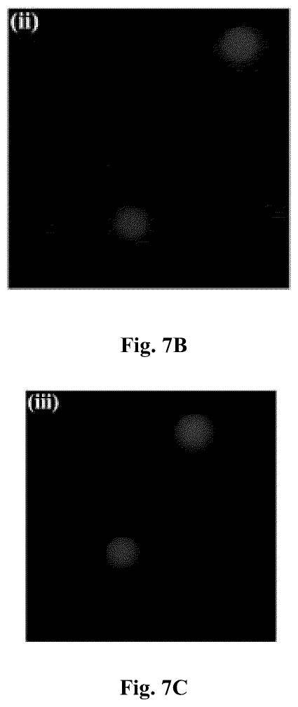

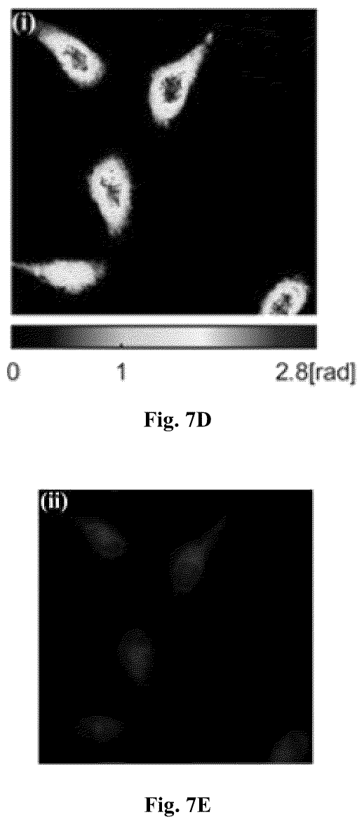

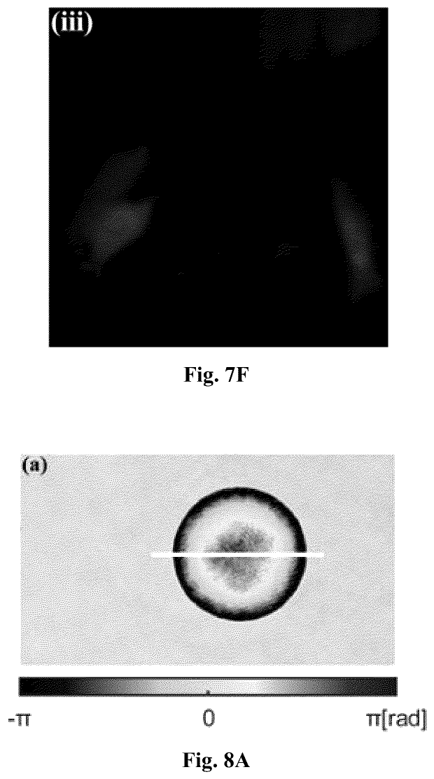

The system in this application example provides two light sources with different wavelengths, which can also be used for fluorescence imaging and phase imaging with the same camera. To illustrate the combined phase-fluorescence imaging capability, this application example conducts both phase measurements and fluorescence imaging experiments on commercially available standard fluorescent particles and Mouse Embryonic Fibroblast Cells (NIH 3T3). The results are shown in FIGS. 7A-7F.

The standard fluorescent particles made of polystyrene have been coated with Nile Blue dye on the surface. Its maximum excitation wavelength is 620 nm, and its maximum emission wavelength is 680 nm. In this application example, a 633 nm light source is selected for excitation, and a long-wavelength band-pass filter with a cut-off wavelength of 650 nm is placed in front of the camera lens. On the other hand, the 532 nm light source is used for quantitative phase imaging, and the topography information can be analyzed as the experimental results shown in FIGS. 7A to 7C, which agree with the manufacturer's size. Researches have shown that this fluorescent dye can bind to lipid molecules and is usually used to reveal cell membranes and other biological membranes. Further this fluorescent dye can also be used to stain biological cells. Before imaging, the NIH 3T3 cells were processed by staining treatment with 0.1 mg/ml Nile Blue Sulfate for 8 minutes. Then the cells were imaged directly in culture dish, surrounded by the culture medium. The quantitative phase image of dye-stained cells is shown in FIG. 7D. FIG. 7E shows a fluorescence image of the same cell as FIG. 7D, in which a strong red emission can be seen in many amounts of lipids distributed on the cell membrane. Combining the phase test results and the fluorescence test results, it can further help to analyze the topography information and internal molecular structure information of the displayed cells, which clearly distinguishes cell structures such as cell membranes, cytoplasm and nuclear area, and performs cell state analysis. In the M²QPM system, the light for fluorescence imaging and phase imaging can pass through the same optics system and use the same camera, without using dichroic mirrors for separation. The system provided by this application example is simple, more compact and less costly. Comparing the imaging results of FIG. 7E and FIG. 7F or the imaging results of FIG. 7B and FIG. 7C, it is obvious that the fluorescence imaging of this application example has a clearer image than the fluorescence imaging obtained by other technologies.

### 4. Phase Unwrapping

In quantitative phase imaging, for an object or sample with an optical depth greater than the wavelength of the illumination, the phase image contains 2π discontinuities. However, most of the existing phase unwrapping algorithms used to eliminate discontinuities require subjective intervention, such as the Goldstein phase unwrapping algorithm. Here, this application example proposes a measurement method to physically solve the problem of discontinuous phase measurement results obtained when there are height steps on the object that are greater than the wavelength of the illumination. In the M²QPM system, the dual-wavelength phase retrieval method simplifies the image processing process and expands the clear phase range by processing two phase profiles and creating a phase profile corresponding to the synthetic wavelength, which is much longer than any wavelength of light used in the experiment. This method has the ability to maintain high phase sensitivity and stability while measuring 3D contours of samples up to tens of microns that cannot be measured by single-wavelength illumination. In the experiment, the accuracy of the phase unwrapping method based on multi-wavelength testing and synthetic wavelength guidance was verified by measuring 50 μm standard beads, and further compared with the classic phase unwrapping algorithm. Specifically, imaging applications are performed on steep and optically thick structures such as channel structures on microfluidic chips.

In the experiment, the center wavelengths of the two lasers are λ₁=633 nm and λ₂=532 nm, respectively. For testing with samples, the phase maps extracted for each wavelength channel are φ₁(x,y) and φ₂(x,y). According to the following equation (1), the synthetic wavelength can be obtained:

$$Λ = \frac{{λ}_{1} \cdot λ2}{{λ}_{2} - {λ}_{1}} \qquad ( 1 )$$

The resulting synthetic wavelength Λ=3334.2 nm. Subtract the phases of these two wavelength channels to obtain the phase map corresponding to the combined wavelength:

$${φ}_{Λ} ( x , y ) = {φ}_{2} ( x , y ) - {φ}_{1} ( x , y ) \qquad ( 2 )$$

After subtraction, there may be some phase jumps due to the wrapping mismatch between these two wrapped phase maps corresponding to the two wavelengths. When the difference is negative, the mismatching problem can be solved by adding a period of 2π. In this case, the sample height can be calculated by the following formula:

$$H = \frac{{φ}_{1} ( x , y ) {λ}_{1}}{2 πΔ n} = \frac{{φ}_{2} ( x , y ) {λ}_{2}}{2 πΔ n} = \frac{{φ}_{Λ} ( x , y ) Λ}{2 πΔ n} \qquad ( 3 )$$

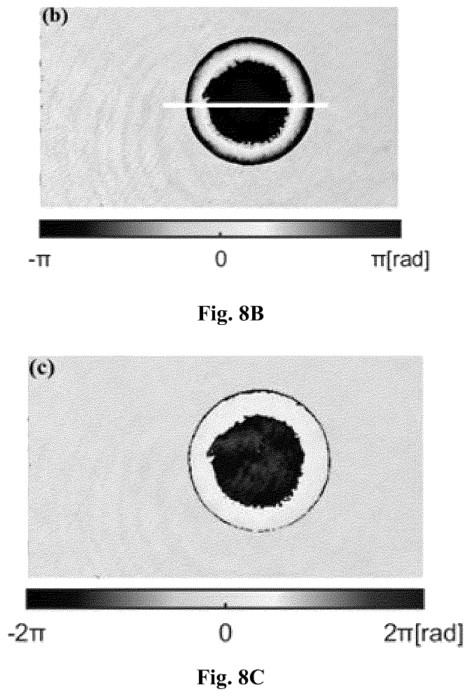

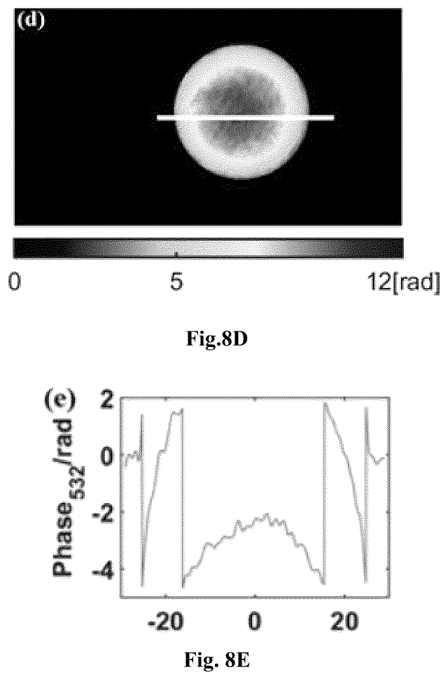

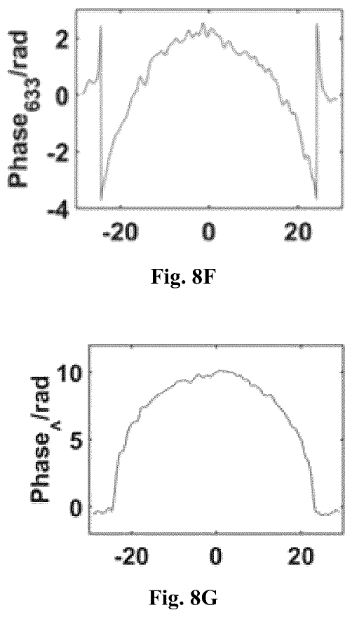

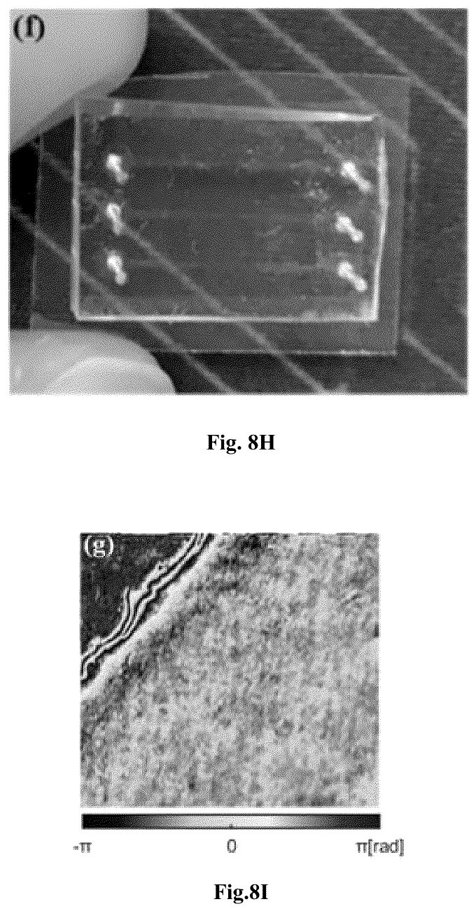

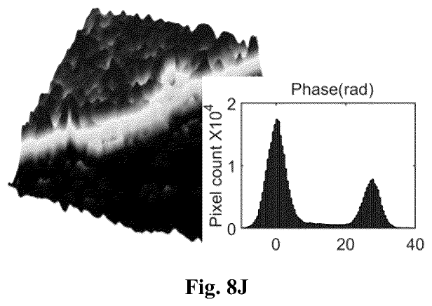

The two-wavelength phase retrieval and unwrapping process is shown in FIGS. 8A-8J. The retrieved phase maps without phase unwrapping algorithm processing on a 50 μm magnetic bead at 633 nm and 532 nm wavelengths are shown in FIGS. 8A and 8B. Based on equation (2), the real phase map corresponding to the synthetic wavelength can be obtained, which can be as shown in FIG. 8C. Then, the phase map corresponding to the synthetic wavelength is unwrapped by the unwrapping progress, and the result can be as shown in FIG. 8D.

In single-wavelength phase images, the phase unwrapping process usually uses conventional algorithms, which may cause problems. A typical software unwrapping algorithm starts at a specific point in the image and moves along a one-dimensional path (for example, a straight line, a spiral). If it encounters something that looks like a phase wrap, the phase is shifted down or up by 2π. When the phase change caused by the real sample structure is greater than 2×, the phase change is discontinuous at this time, and the traditional unwrapping algorithm based on step iteration will obviously cause errors. Exemplarily, in order to test this type of structure, this application example provides a 5 μm high PDMS microchannel, and the physical image is shown in FIG. 8H. Use two different wavelengths of light to test the sample provided in FIG. 8H with our system to obtain the phase map corresponding to the synthetic wavelength. When the M²QPM system of this application example is used to image a target in one exposure, the corresponding wrapping phase maps in the two wavelength channels are retrieved, as shown in FIGS. 8A and 8B. In FIGS. 8A and 8B, there is a steep jump at the step position, which cannot be solved simply by the digital unpacking algorithm. However, after applying the two-wavelength phase unwrapping method of this application example, it can be obtained from FIG. 8G that the phase profile after unwrapping is continuous. Further, the height measurement result caused by the profile difference between the two parts is consistent with the production design. The test results of this sample verify the universality and accuracy of this process of the synthetic wavelength-guided phase unwrapping algorithm.

This application example proposes and demonstrates a new type of portable multi-modal and multi-wavelength fiber-based quantitative phase microscope (M²QPM), in which the interferometric measurement is realized by tuning the optical path length of the reference beam through a single-mode optical fiber. In this setup, the light mainly propagates in the coiled optical fibers instead of free space, which can achieve a compact size and high sensitivity. With fiber couplers and fiber combiners, the system are able to simultaneously illuminate the sample with two different wavelengths of light and obtain their interferograms in a single acquisition. Since the sample information corresponding to the light of two different wavelengths does not overlap in the spatial frequency space, the phase map of each wavelength channel can be fully reconstructed based on the interferogram obtained by the system. Based on the retrieved phase map, this application example can explore various applications, such as detecting the dispersion properties of dispersive samples, showing multi-modal quantitative phase and fluorescence images, and characterizing optically thick structures.

According to the embodiments of the disclosure herein, the disclosure herein also provides a readable storage medium and a computer program product.

Various implementations of the systems and technologies described in this article can be implemented in digital electronic circuit systems, integrated circuit systems, field programmable gate arrays (FPGA), application specific integrated circuits (ASIC), application-specific standard products (ASSP), system-on-chip SOC, load programmable logic device (CPLD), computer hardware, firmware, software, and/or their combination. These various embodiments may include: being implemented in one or more computer programs, the one or more computer programs may be executed and/or interpreted on a programmable system including at least one programmable processor, the programmable processor It can be a dedicated or general-purpose programmable processor that can receive data and instructions from the storage system, at least one input device, and at least one output device, and transmit the data and instructions to the storage system, the at least one input device, and the at least one output device. An output device.

The program code used to implement the method of the disclosure herein can be written in any combination of one or more programming languages. These program codes can be provided to the processors or controllers of general-purpose computers, special-purpose computers, or other programmable data processing devices, so that when the program codes are executed by the processors or controllers, the functions specified in the flowcharts and/or block diagrams/The operation is implemented. The program code can be executed entirely on the machine, partly executed on the machine, partly executed on the machine and partly executed on the remote machine as an independent software package, or entirely executed on the remote machine or server.

It should be understood that the various forms of processes shown above can be used to reorder, add or delete steps. For example, the steps described in the disclosure herein can be executed in parallel, sequentially, or in a different order, as long as the desired result of the technical solution disclosed in the disclosure herein can be achieved, this is not limited herein.

The foregoing specific implementations do not constitute a limitation on the protection scope of the disclosure herein. Those skilled in the art should understand that various modifications, combinations, sub-combinations and substitutions can be made according to design requirements and other factors. Any modification, equivalent replacement and improvement made within the spirit and principle of the disclosure herein shall be included in the protection scope of the disclosure herein.

What is claimed is:

1. A device for quantitative phase imaging, comprising:
at least two light sources with different wavelengths;
at least two fiber couplers;
an optical fiber combiner;
a first collimator lens;
a sample platform;
a 4f system;
at least two cubic beam splitters, each cubic beam splitter is equipped to combine the input sample beam and one reference beam; and a kinematic mount is arranged to adjust the angle of the reference beam and then this beam is collimated with a second collimator lens; and
a camera;
wherein the first collimator lens, the sample platform, the 4f system, the at least two cubic beam splitters, and the camera are placed in sequence, and their centers are on the same optical axis;
the imaging of the device comprises:
the optical fiber coupler divides any light beam input from the at least two light sources with different wavelengths into two beams, one of the two beams is input into the optical fiber combiner through an optical fiber, and the other of the beams as a reference beam is input into one of the at least two cube beam splitters through an optical fiber, and the optical fiber combiner combines the input beams and outputs a sample beam, which passes through the first collimator lens to illuminate the sample on the sample platform and penetrates into the at least two cubic beam splitters to combine with the reference beams therein, thus a multiplexed interferogram of the sample is captured by the camera.

2. The device according to claim 1, wherein the sample is coated with fluorescent dyes, a band-pass filter is placed in front of the camera plane, and the imaging of the device comprises:
an excitation light source selected from the at least two light sources, with a wavelength close to the maximum excitation wavelength of the fluorescent dyes, emits a light beam to pass through the first collimator lens and then to illuminate the sample coated with the fluorescent dyes to make it emit a fluorescence, and the fluorescence sequentially passes through the 4f system and the at least two cube beam splitters, and then the camera captures a fluorescence imaging image of the sample; wherein the cut-off wavelength of the long-pass filter is longer than the wavelength of the excitation light source.

3. The device according to claim 1, further comprising a processor configured to:
receive the multiplexed interferogram of the sample from the camera of the device; and
perform a phase retrieval on the multiplexed interferogram to obtain a phase map of the sample at the wavelength of each beam that synthesizes the sample beam.

4. The device according to claim 3, wherein there are at least two light beams with wavelengths of a first wavelength and a second wavelength that synthesizes the sample beam and the processor is configured to:
determine a synthesized phase map of the sample at the wavelength synthesized by the first wavelength and the second wavelength, according to the phase map of the sample at the first wavelength and that at the second wavelength; and
add a period of 2π on each negative phase in the synthesized phase map to obtain an unwrapping phase map.

5. The device according to claim 4, wherein the processor is further configured to:
perform a height conversion on the unwrapping phase map and the synthesized wavelength to obtain a height map of the sample.

6. The device according to claim 3, wherein there are at least two light beams with wavelengths of a first wavelength and a second wavelength that synthesizes the sample beam, and the processor is further configured to:
Determine a ratio of the refractive index contrast of the sample at the first wavelength and at the second wavelength, according to the phase map of the sample at the first wavelength and that at the second wavelength.

7. The device according to claim 5, wherein the sample is red blood cells, and the processor is used for:
determine a hemoglobin concentration in the red blood cells, according to the relative average refractive index and two phase maps of the red blood cells at the wavelengths of any two light beams that synthesize the sample beam.

8. A method for quantitative phase imaging, comprising:
obtaining a multiplexed interferogram of a sample, where the multiplexed interferogram is an imaging map captured by a camera when a sample beam synthesized of at least two beams with different wavelengths to illuminate the sample and then penetrate into the cube beam splitter to combine with the at least two beams of different wavelengths as reference beams, and finally the combined beam is sampled by the camera; and
performing a phase retrieval on the multiplexed interferogram to obtain a phase map of the sample at the wavelength of each beam that synthesizes the sample beam.

9. The method according to claim 8, wherein there are at least two light beams with wavelengths of a first wavelength and a second wavelength that synthesizes the sample beam and the method further comprises:
Determining a synthesized phase map of the sample at the wavelength synthesized by the first wavelength and the second wavelength, according to the phase map of the sample at the first wavelength and that at the second wavelength; and
adding a period of 2π on each negative phase in the synthesized phase map to obtain an unwrapping phase map.

10. The method according to claim 9, wherein the method further comprises:
performing a height conversion on the unwrapping phase map to obtain a height map of the sample.

11. The method according to claim 8, wherein there are at least two light beams with wavelengths of a first wavelength and a second wavelength that synthesizes the sample beam and the method further comprises:
determining a ratio of the refractive index contrast of the sample at the first wavelength and at the second wavelength, according to the phase map of the sample at the first wavelength and that at the second wavelength.

12. The method according to claim 8, wherein the sample is red blood cells, and the method further comprises:
determining a hemoglobin concentration in the red blood cells, according to the relative average refractive index and two phase maps of the red blood cells at the wavelengths of any two light beams that synthesize the sample beam.

13. A non-transitory computer-readable storage medium storing computer instructions, wherein the computer instructions are used to make a computer execute the method according to claim 8.
